(19) United States
(12) Patent Application Publication
(10) Pub. No.: US 2013/0146535 A1
(43) Pub. Date: Jun. 13, 2013

(54) METHOD FOR MONITORING AND/OR CONTROLLING THE PROCESS FLOW OF A WASTE WATER SYSTEM AND SYSTEM FOR PERFORMING THE METHOD

(71) Applicant: Endress + Hauser Conducta Gesellschaft fur Mess-und Regeltechnik mbH + Co. KG, Gerlingen (DE)

(72) Inventor: Joachim Albert, Leonberg (DE)

(73) Assignee: Endress + Hauser Conducta Gesellschaft fur Mess- und Regeltechnik mbH + Co. KG, Gerlingen (DE)

(21) Appl. No.: 13/693,508

(22) Filed: Dec. 4, 2012

(30) Foreign Application Priority Data
Dec. 6, 2011 (DE) 10 2011 087 825.4

(51) Int. Cl. C02F 1/00

(52) U.S. Cl. CPC C02F 1/008
USPC 210/614; 210/739; 210/744; 210/743; 210/745; 210/742; 210/746

(57) ABSTRACT

A method for monitoring and/or controlling the process flow of a waste water system having waste water in waste water lines, comprising the steps as follows: measuring volume flow of waste water at a location remote from a waste water cleaning plant; measuring at least one additional waste water relevant parameter at the location remote from the waste water cleaning plant; evaluating the measurement data and detecting system relevant events; and undertaking measures in the waste water cleaning plant and/or at the location remote from the waste water cleaning plant as a function of the system relevant event. Furthermore, the invention relates to a system for performing the method.

The invention relates to a method for monitoring and/or controlling the process flow of a waste water system and a system for performing the method.

A waste water cleaning plant serves for cleaning waste water collected by a drain system having waste water lines and transported thereby to the plant.

In Europe and North America, efforts are currently being made, based on a good infrastructure, to introduce measures for plant optimization and -maintenance, as well as for improving water quality. Moreover, stricter laws for environmental protection are being developed. Current examples for this include the European discussions concerning hormone- and pesticide removal in clarification plants. This means that, worldwide, requirements for clean water are becoming ever greater.

In turn, these requirements have to be achieved at the local level. The waste water cleaning plant is, as a rule, the greatest electrical power consumer of a community. Approximately 40% to 60% of the electrical power consumption of a community can be attributed to waste water cleaning. The greatest electrical power consumption in this, at about 70%, goes for activation. Investigations in Germany have shown that, using a structured approach, savings of up to 40% are possible.

Especially blowers and aerators for the activation offer large energy savings potential. Any measures in this direction must, however, not lead to a decrease in the quality of the discharge from the waste water cleaning plant. It has been found that measured and thoughtful plant operation for energy minimization leads simultaneously to improved discharge values and therewith to improved water quality.

At various times, the inflow of a waste water cleaning plant is checked with appropriate sensors. Waste water relevant parameters include, for example, pH-, oxygen-, nitrate-, nitrite-, ammonium-, chlorine-, potassium-, and phosphate-content, SAC, certain global parameters, especially chemical and/or biochemical oxygen demand, the content of (dissolved) organics, especially the total (dissolved) carbon, temperature, conductivity, redox potential and turbidity. Besides sensors in probe form, also sensors can be applied in, or in the form of, wet analyzers.

Thus, load peaks are detected directly in front of the waste water cleaning plant and the waste water cleaning plant is then prepared for the load. A second measuring in the process flow checks the clarified water. A uniform, stable operation of the plant helps toward optimizing energy consumption.

The time that passes between detecting a load peak and its arrival in the activation section of the plant amounts to an hour, for instance. Often this time is not sufficient to prepare the activation section appropriately for the load. In order to assure the safe operation of the waste water cleaning plant, especially its activation section, a greatest possible time between detecting the load peak and the arrival of the load is advantageous.

This is especially important in the case of system relevant events, in the case of which the load must not reach the environment. Included among ‘events’ here are traffic accidents, industrial accidents and accidents at private residences involving oil, pharmaceutical, biological or chemical, poisonous substances, or other damaging substances. A system relevant event is thus preferably defined as an event, in the case of which at least one measured waste water relevant parameter lies below, or above, a threshold value, for example, when the pH-value is too high.

An object of the invention, therefore, is to provide a method and a system, which assure a safe and energy saving operation of a waste water cleaning plant.

The object is achieved by a method comprising steps as follows:
Measuring volume flow of waste water at a location remote from a waste water cleaning plant,
measuring at least one additional waste water relevant parameter at the location remote from the waste water cleaning plant,
evaluating the measurement data and detecting system relevant events, and
undertaking measures in the waste water cleaning plant and/or at the location remote from the waste water cleaning plant as a function of the system relevant event.

This is advantageous, since, by measuring waste water relevant parameters at a location remote from the waste water cleaning plant, time can be won, until the waste water arrives at the waste water cleaning plant. Thus, measures can be timely undertaken, in order to operate the waste water cleaning plant with greatest possible energy savings. The remote location is usually some kilometers removed from the waste water cleaning plant; it is, however, also possible that the location lies directly in front of the waste water cleaning plant.

In a preferred embodiment, the measuring of the volume flow and of the at least one additional waste water relevant parameter occurs at a first point in time, and the measures in the waste water cleaning plant are finished, at least, however, prepared, by a second point in time, at the latest, by the arrival of the system relevant event in the waste water cleaning plant.

In an advantageous form of embodiment, the measures at the location remote from the waste water cleaning plant include especially
complete or partial closing of waste water lines and detouring of the waste water into a waste water structure as a function of its fill level,
complete or partial opening of waste water lines, and/or
introducing chemical and/or biological means suitable for the system relevant event, especially for neutralizing the system relevant event.

An advantage lies in the fact that system relevant events, as defined above, can be led into a waste water structure and so separately disposed of there. Also, an option is that means for neutralizing the system relevant event are applied. Especially, this can be used in the case of industrial waste water cleaning plants.

In a preferred embodiment, the measures in the waste water cleaning plant include especially
controlling aeration,
controlling slurry feedback pumps,
controlling recirculation pumps, and/or
introducing chemical and/or biological means suitable for the system relevant event, especially for neutralizing the system relevant event.

By performing the named measures, maximum energy efficiency can be pursued.

Preferably, the measuring of the at least one additional waste water relevant parameter is accomplished using a pH-, redox-potential-, oxygen-, nitrate-, nitrite-, ammonium-, chlorine-, potassium-, phosphate-, SAC-, or temperature sensor or a sensor for measuring at least one global parameter, especially chemical and/or biochemical oxygen demand, conductivity, turbidity or (dissolved) organic ingredients, especially total (dissolved) carbon.

In order that, for later analyses in the laboratory or for legal purposes, samples are available, preferably samples of waste water are stored in suitable storage containments to document occurrence of system relevant events.

Advantageously used for communication, especially for transmission, of measurement data and/or disturbance reports, are wired solutions, such as Profibus, Ethernet, ModBus, HART, DSL, ISDN or analog telephone networks, or wireless solutions, such as wireless HART, Bluetooth, WiMAX or mobile radio technologies, especially GSM, especially HSCSD, GPRS and EDGE, UMTS, especially HSPA or HSPA+, or LTE, as well as LTE advanced.

In a preferred embodiment, the measurement data of a rain sensor and/or an Internet based weather service are included for evaluating the measurement data and taken into consideration for detecting system relevant events.

This is advantageous: If these are not taken into consideration, it can happen that a system relevant event is transported past the waste water cleaning plant and directly into the environment.

The object is furthermore achieved by a system for performing the method, comprising
A waste water cleaning plant at a first location;
at least a first field device for measuring volume flow of waste water at a second location remote from the waste water cleaning plant;
at least a second field device for measuring at least one additional waste water relevant parameter at the second location;
at least one superordinated unit for evaluating the measurement data of the first field device and/or of the second field device and detecting system relevant events; and
at least a third field device for complete or partial closing of waste water lines and detouring of waste water into a waste water structure as a function of its fill level, or complete or partial opening of waste water lines.

This is advantageous, since, by measuring waste water relevant parameters at a second location remote from the waste water cleaning plant, time can be won, until the waste water arrives at the waste water cleaning plant. Thus, measures can be timely undertaken, in order to operate the waste water cleaning plant in a most energy saving manner as possible. The second location is usually some kilometers removed from the waste water cleaning plant. However, it is possible that the location lies directly before the waste water cleaning plant.

In a preferred embodiment, open or closed loop control of the first field device, the second field device and/or the third field device is implemented by the superordinated unit.

The invention will now be explained based on the drawing, the figures of which show as follows:

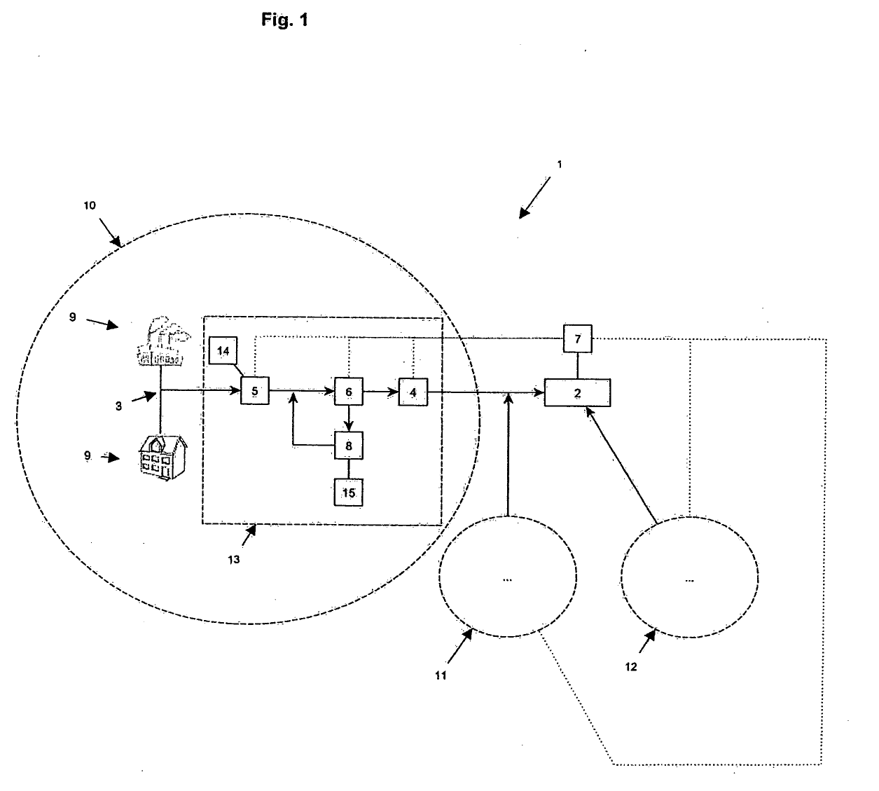

FIG. 1 a schematic diagram of the system of the invention; and

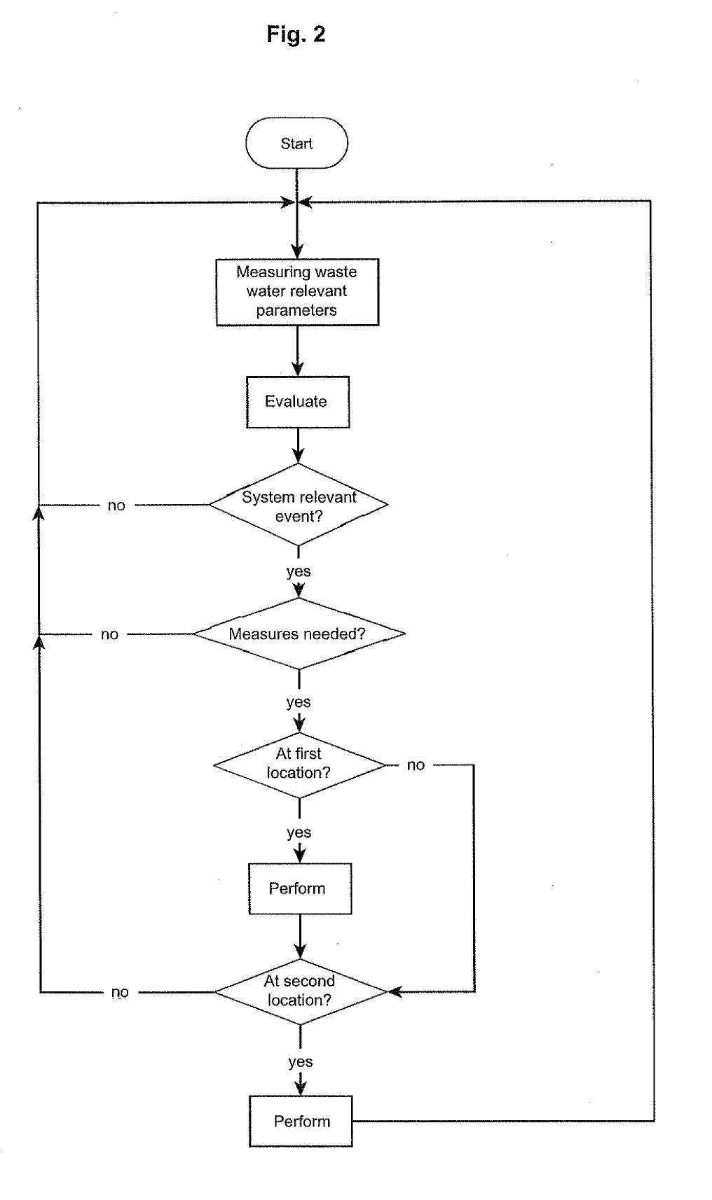

FIG. 2 a flow diagram of the method of the invention.

FIG. 1 shows the system of the invention, which is designated in its totality with the reference character 1. System 1 is composed, on the one hand, of a waste water cleaning plant 2, which is fed waste water via waste water lines 3.

On the other hand, the system 1 is composed of different measuring zones 10, 11, 12. A measuring zone can, in such case, be, for example, a city district or an industrial park. Shown in FIG. 1 are a first measuring zone 10, a second measuring zone 11 and a third measuring zone 12, wherein the second measuring zone 11 and the third measuring zone 12 are waste water technically identical with the first measuring zone 10. From reasons of perspicuity, details of the second measuring zone 11 and the third measuring zone 12 are not shown. It is conceivable that other measuring zones are connected with the waste water cleaning plant 2. Also, a plurality of measuring zones can be connected in series. Furthermore, another option is a main measuring zone with one or more ancillary measuring zones.

A measuring zone 10, 11, 12 includes different consumers 9, such as, for instance, households, small businesses, industrial plants, etc.

Waste water of the consumers 9 is removed in waste water lines 3 and flows to a measuring point 13. Measuring point 13 is located in the course of the waste water, before the waste water cleaning plant 2, at a location remote from the waste water cleaning plant 2. This can be directly before the waste water cleaning plant 2 but is usually remote from the waste water cleaning plant 2, in a city district, industrial park, etc.

Measuring point 13 includes at least a first field device 4 and a second field device 5. The first field device 4 is embodied as a flow sensor for measuring volume flow of the waste water. The second field device 5 is a sensor for measuring at least one additional waste water relevant parameter. Options include a pH-, redox-potential-, oxygen-, nitrate-, nitrite-, ammonium-, chlorine-, potassium-, phosphate-, SAC-, or temperature sensor or a sensor for measuring at least one global parameter, especially chemical and/or biochemical oxygen demand, conductivity, turbidity or (dissolved) organic ingredients, especially total (dissolved) carbon. Also, a so-called multisensor can be used. A multisensor is a sensor, which is able to measure a plurality of parameters (simultaneously).

Connected between first field device 4 and second field device 5 is a third field device 6. The third field device 6 is an actuator for controlling the waste water flow. The third field device 6 is, thus, a waste water line blocking mechanism, penstock, control gate, lock or other apparatus embodied to change the flow of the waste water.

Connected laterally to the main flow of the waste water is a waste water structure 8. The waste water structure 8 can be embodied for rain removal, for instance as a rain overflow basin, buffer system or storage basin. Also, the waste water structure 8 can be embodied as a pumping station. Especially, when the consumer 9 lies at a lower elevation than the waste water cleaning plant 2, pumping stations are necessary.

FIG. 1 shows the waste water structure 8 to be laterally connected, rather than in the main flow. The following states are possible for the third field device 6 relative to the waste water handling structure 8:
Waste water flows past the waste water structure 8 (“gate open”),
waste water is completely detoured into the waste water structure 8 (“gate closed”),
waste water flows partially past the waste water structure 8 and is partially detoured into the waste water structure 8.

If the second field device 5 detects a system relevant event (examples include, for instance, an oil accident, chemical accident, etc.; in general: environmentally damaging material is detected), i.e. at least one measured parameter lies outside a permitted measuring range, then the third field device 6 can close the gate and the waste water is completely detoured into the waste water structure 8. Thus, the system relevant event can be stored in the waste water structure 8. Samples of the stored waste water can be taken for later analytical purposes or for legal reasons. Also, the system relevant event can be pumped out of the waste water structure 8 and into external means, for instance, a tank truck, and separately disposed of.

It is, moreover, an option that the waste water structure 8 is located in the main flow, i.e. the waste water structure 8 is embodied as a backwater handling structure, detention basin or the like.

The measuring of the at least one additional waste water relevant parameter using the second field device 5 happens timely before the waste water cleaning plant 2. This means it is possible to begin in the waste water cleaning plant 2 with suitable measures, such as
controlling aeration,
controlling slurry feedback pumps, and/or
controlling recirculation pumps.

It is desired to have as great a lead time as possible, so that the waste water cleaning plant 2 can be operated as energy efficiently as possible.

Associated with the second field device 5 is a rain sensor 14 for detection of rain. Furthermore, a fill level sensor 15 is associated with the waste water structure 8 for detection of the fill level of the waste water structure 8.

If environmentally damaging material is located in the waste water structure 8 and it rains, it must be assured that the environmentally damaging material is not transported past the waste water cleaning plant 2 and into the environment. With the help of the level sensor 15, it can also be assured that the waste water structure 8 does not overflow to possibly transport environmentally damaging material located in the waste water structure 8 directly into the environment. It is necessary to know the current fill level and the weather prediction, in order, in an emergency, to advance the environmentally damaging material timely into the waste water cleaning plant 2.

Besides the detection of rain directly via the rain sensor 14, an option is that weather predictions via an Internet based weather service are used, in order to receive predictions concerning the weather. Based on the prognosis, the field devices 4, 5, 6 can be correspondingly checked. In the cases of doubt, the volume flow control has precedence.

Open or closed loop control of the first field device 4, the second field device 5 and the third field device 6 is accomplished with a superordinated unit 7. Most often there is one superordinated unit 7 for all field devices 4, 5, 6. The superordinated unit 7 is located usually at the waste water cleaning plant 2 and can be part of the control system for the plant, i.e. part of the waste water routing management system. The connection of superordinated unit 7 to field device 4, 5, 6 occurs, in such case, wired via a fieldbus technology, such as Profibus, ModBus or HART, Ethernet, DSL, ISDN or via analog telephone networks, or wirelessly via wireless HART, Bluetooth, WiMAX or mobile radio technologies, such as GSM or UMTS.

Superordinated unit 7 collects also information from the other sensors, especially the rain sensor 14 and the fill level sensor 15. The measurement data of these sensors 14, 15 are incorporated into the control of the field devices 4, 5, 6. Usually, the sensors 14, 15 communicate with the superordinated unit 7 using the same technologies as the field devices 4, 5, 6.

With the help of the measurement data of sensors 14, 15 and field devices 4, 5, 6, the superordinated unit 7 can decide whether a system relevant event is present and introduce corresponding measures.

Also, the superordinated unit 7 can take into consideration that, in the case of longer dryness and resultant deposits in the waste water drainage system, such deposits can, in the case of rain, get into the waste water cleaning plant 2 as so-called storm surge, so that corresponding measures must be introduced, especially in the activation part of the plant.

If a number of measuring zones 10, 11, 12 are connected to the waste water cleaning plant 2, the superordinated unit 7 coordinates their measurement data and controls the corresponding field devices.

Fundamentally, it is possible to have the measuring point 13 of each measuring zone act autarkically. This means that the measuring point 13 functions independently of the superordinated unit 7. If required, the superordinated unit 7 can intercede and take over, or influence, the control.

FIG. 2 illustrates the course of a system relevant event, as such was described above.

As already mentioned, continuously (or in certain intervals), the waste water of the consumer 9 is measured as regards flow and at least one additional waste water relevant parameter thereof is also measured. If at least one parameter lies below, or above, a threshold value, then the superordinated unit 7 evaluates whether a system relevant event is present and faultless operation of the waste water cleaning plant 2 is endangered. If is this is evaluated as negative, measurement goes on (continuously).

If the evaluation comes out positive, the superordinated unit 7 decides whether measures must be undertaken. It is also an option that this decision is not made automatically, but, instead, by technicians of the waste water cleaning plant. Thus, the superordinated unit 7 can issue for the technicians a corresponding report, for example, with the measured value, clock time and location. If no technicians are on-site, from today's point of view, a wireless transmission of the information with mobile radio technology is the most practical; however, wired solutions with analog/digital telephone connection or DSL also represent options.

It is, at any time, an option that the superordinated unit 7 and/or the measuring point 13 issue(s) a report/alarm for the technicians.

If the decision concerning the undertaking of measures is negative, measurement goes on (continuously).

If the decision concerning the undertaking of measures is positive, it is decided where and what must be done.

As already mentioned, it is also an option that superordinated unit 7 gets involved only in the case of need and the measuring point 13 otherwise works autarkically.

In FIG. 2, the first location is defined to be the waste water cleaning plant 2, and the second location is the waste water structure 8. Usually, the waste water structure 8 is situated at a location, which is a number of kilometers away from the waste water cleaning plant 2; however, a waste water structure 8 can also be directly in front of the waste water cleaning plant 2.

Measures, which can be performed at the second location, include, for example, complete or partial closing of waste water lines and detouring of waste water into a waste water structure as a function of its fill level, complete or partial opening of waste water lines, and/or introducing chemical and/or biological means suitable for the system relevant event, especially means for neutralizing the system relevant event.

Measures, which can be performed at the first location, i.e. at the waste water cleaning plant 2, include, for example, controlling aeration, controlling slurry feedback pumps, controlling recirculation pumps, and/or introducing chemical and/or biological means suitable for the system relevant event, especially means for neutralizing the system relevant event.

Of course, the measures must not endanger the faultless operation of the waste water cleaning plant 2.

If a system relevant event occurs, for example, an accident involving an oil discharge, then this is classified as system relevant based on the measured parameters. The waste water with oil is detected at a location remote from the waste water cleaning plant 2, wherein “location remote” is understood to mean remote both spatially as well as also in time. If it is detected that a neutralizing is not possible and faultless operation of the waste water cleaning plant 2 is endangered, then the waste water with oil can be transported into the waste water structure 8. There, it can then be pumped off and professionally disposed of.

If it is determined that the waste water cleaning plant 2 can handle the event, only not in the present amount, then the event can be stored interimly in the waste water structure 8 and transported to the waste water cleaning plant 2 in smaller amounts, mixed with “normal” waste water. In this way, it is not necessary to consume additional energy in the waste water cleaning plant 2, in order to process load peaks.

As already mentioned, the measurement results of the rain sensor 14 and the level sensor 15 are taken into consideration in the processing of the system relevant event.

In general, the goal is to make the amount of advance warning between detection of the system relevant event and arrival of the event at the waste water cleaning plant as long as possible.

Based on this forward-looking knowledge, the waste water cleaning plant can be prepared optimally for an event and, thus, be operated energy efficiently.

### LIST OF REFERENCE CHARACTERS

1 system
2 waste water cleaning plant
3 waste water line
4 first field device
5 second field device
6 third field device
7 superordinated unit
8 waste water structure
9 consumer
10 first measuring zone
11 second measuring zone
12 third measuring zone
13 measuring point
14 rain sensor
15 fill level sensor

1-10. (canceled)

11. A method for monitoring and/or controlling the process flow of a waste water system having waste water in waste water lines, comprising the steps of:
measuring volume flow of waste water at a location remote from a waste water cleaning plant;
measuring at least one additional waste water relevant parameter at the location remote from the waste water cleaning plant;
evaluating the measurement data and detecting system relevant events; and
undertaking measures in the waste water cleaning plant and/or at the location remote from the waste water cleaning plant as a function of the system relevant event.

12. The method as claimed in claim 11, wherein:
said measuring of the volume flow and of the at least one additional waste water relevant parameter occurs at a first point in time; and
the measurements in the waste water cleaning plant are finished, at least, however, prepared, by a second point in time, at the latest, by the arrival of the system relevant event in the waste water cleaning plant.

13. The method as claimed in claim 11, wherein:
measurements at the location remote from the waste water cleaning plant include, especially: complete or partial closing of waste water lines and detouring of waste water into a waste water structure as a function of its fill level, complete or partial opening of waste water lines, and/or
introducing chemical and/or biological means suitable for the system relevant event, especially for neutralizing the system relevant event.

14. The method as claimed in claim 11, wherein:
the measurements in the waste water cleaning plant include especially: controlling aeration, controlling slurry feedback pumps, controlling recirculation pumps, and/or introducing chemical and/or biological means suitable for the system relevant event, especially for neutralizing the system relevant event.

15. The method as claimed in claim 11, wherein:
said measuring of the at least one additional waste water relevant parameter is accomplished using a pH-, redox-potential-, oxygen-, nitrate-, nitrite-, ammonium-, chlorine-, potassium-, phosphate-, SAC-, or temperature sensor or a sensor for measuring at least one global parameter, especially chemical and/or biochemical oxygen demand, conductivity, turbidity or (dissolved) organic ingredients, especially total (dissolved) carbon.

16. The method as claimed in claim 11, wherein:
samples of waste water are stored in suitable storage containments to document occurrence of system relevant events.

17. The method as claimed in claim 11, wherein:
used for communication, especially for transmission, of measurement data and/or disturbance reports, are wired solutions, such as Profibus, Ethernet, ModBus, HART, DSL, ISDN or analog telephone networks, or wireless solutions, such as wireless HART, Bluetooth, WiMAX or mobile radio technologies, especially GSM, especially HSCSD, GPRS and EDGE, UMTS, especially HSPA or HSPA+, or LTE as well as LTE-advanced.

18. The method as claimed in claim 11, wherein:
the measurement data of a rain sensor and/or an Internet based weather service are included for evaluating the measurement data and taken into consideration for detecting system relevant events.

19. A system for performing the method of: monitoring and/or controlling the process flow of a waste water system having waste water in waste water lines, comprising the steps of: measuring volume flow of waste water at a location remote from a waste water cleaning plant; measuring at least one additional waste water relevant parameter at the location remote from the waste water cleaning plant; evaluating the measurement data and detecting system relevant events; and undertaking measures in the waste water cleaning plant and/or at the location remote from the waste water cleaning plant as a function of the system relevant event; at least in a waste water system having waste water in waste water lines, the system comprising:
a waste water cleaning plant at a first location;
at least a first field device for measuring volume flow of waste water at a second location remote from the waste water cleaning plant;
at least a second field device for measuring at least one additional waste water relevant parameter at the second location;
at least one superordinated unit for evaluating the measurement data of said first field device and/or of said second field device and detecting system relevant events; and
at least a third field device for complete or partial closing of waste water lines and detouring of waste water into a waste water structure as a function of its fill level, or complete or partial opening of waste water lines.

20. The system as claimed in claim 19, wherein:
open or closed loop control of the first field device, the second field device and/or the third field device is implemented by the superordinated unit.
